(19) United States
(12) Patent Application Publication
(10) Pub. No.: US 2017/0210945 A1
(43) Pub. Date: Jul. 27, 2017

(54) BINDER CONTAINING WHEY PROTEIN

(71) Applicants: KNAUF INSULATION SPRL, Visé (BE); KNAUF INSULATION, INC., Shelbyville (IN)

(72) Inventors: Carl HAMPSON, St. Helens (GB); Benedicte PACOREL, Auckland (NZ)

(21) Appl. No.: 15/324,719

(22) PCT Filed: Jul. 9, 2015
(86) PCT No.: PCT/EP2015/065662

§ 371 Date: Jan. 8, 2017

(30) Foreign Application Priority Data
Jul. 11, 2014 (GB) 1412335.0

(51) Int. Cl. C09D 189/00; C08L 97/02

(52) U.S. Cl. CPC C09D 189/00; C08L 97/02

(57) ABSTRACT

The present invention relates to an aqueous binder composition, a method of manufacturing a product comprising said binder composition in a cured state, as well as particle or fibre products comprising the binder composition in a cured state, and a use of said binder composition.

The present invention relates to an aqueous binder composition, a method of manufacturing a product comprising said binder composition in a cured state, as well as particle or fibre products comprising the binder composition in a cured state, and a use of said binder composition.

Generally, binders are useful in fabricating articles because they are capable of consolidating non- or loosely-assembled matter. For example, binders enable two or more surfaces to become united. In particular, binders may be used to produce products comprising consolidated fibres. Thermosetting binders may be characterized by being transformed into insoluble and infusible materials by means of either heat or catalytic action. Examples of a thermosetting binder include a variety of phenol-aldehyde, urea-aldehyde, melamine-aldehyde, and other condensation-polymerization materials like furane and polyurethane resins. Binder compositions containing phenol-aldehyde, resorcinol-aldehyde, phenol/aldehyde/urea, phenol/melamine/aldehyde, and the like are widely used for the bonding of fibres, textiles, plastics, rubbers, and many other materials.

The mineral wool and wood board industries have historically used a phenol formaldehyde based binder, generally extended with urea. Phenol formaldehyde type binders provide suitable properties to the final products. However, desires for greater sustainability and environmental considerations have motivated the development of alternative binders. One such alternative binder is a carbohydrate based binder derived from reacting a carbohydrate and an acid, for example, U.S. Published Application No. 2007/0027283 and Published PCT Application WO2009/019235. Another alternative binder system uses the esterification products of a polycarboxylic acid and a polyol, for example, U.S. Published Application No. 2005/0202224. Because these binders do not utilize formaldehyde as a reagent, they have been collectively referred to as formaldehyde-free binders.

One area of current development is to find a replacement for the phenol formaldehyde type binders across a large range of products, including products in the building and automotive sector (e.g. mineral wool insulation, wood boards, particle boards, office panels, and acoustical sound insulation). In particular, previously developed formaldehyde-free binders may not possess all of the desired properties. For example, acrylic acid and poly(vinylalcohol) based binders have shown promising performance characteristics for some (but not all) products. However, these are relatively more expensive than phenol formaldehyde binders, are derived essentially from petroleum-based resources, and have a tendency to exhibit lower reaction rates compared to the phenol formaldehyde based binder compositions (requiring either prolonged cure times or increased cure temperatures).

Carbohydrate-based binder compositions are made of relatively inexpensive precursors and are derived mainly from renewable resources. However, these binders may also require reaction conditions for curing that are substantially different from those conditions under which the traditional phenol formaldehyde binder system is cured.

Specifically, a versatile alternative to the above-mentioned phenol formaldehyde binders is the use of carbohydrate polyamine binders which are polymeric binders obtained by reaction of carbohydrates with polyamines having at least one primary amine group. Typically, the carbohydrate polyamine binders are prepared as a solution, such as an aqueous solution, and are subsequently applied onto the loosely assembled matter to be bound. Such wetted loosely assembled matter is then, for example, heat treated to cure the carbohydrate polyamine binder.

Nonetheless, the currently available binder compositions are sometimes linked with drawbacks such as a relatively high loss of water in the condensation reaction during curing, which may have a negative impact on the internal bond strength and/or swelling properties of the products obtained by using the above carbohydrate polyamine binder compositions.

Accordingly, the technical problem underlying the present invention is to provide a binder composition, which is compatible with the established processes, is environmentally acceptable and overcomes the aforementioned problems regarding insufficient internal bond strength and/or swelling properties due to loss of water during curing.

In order to solve the above technical problem, as a first aspect, the present invention provides a method of manufacturing a product using an aqueous binder composition as defined in claim 1. Other aspects are defined in other independent claims. The dependent claims define preferred or alternative embodiments.

According to one aspect, the present invention provides a method of manufacturing a product, notably a product selected from a building product, a mineral wool insulation product, a wood product, an automotive product, a paper product and a refractory product, comprising the steps of:
(a) providing a collection of matter,
(b) applying an aqueous binder composition to the collection of matter, the aqueous binder composition comprising, by dry weight:
i) between 65 wt % and 90 wt % whey protein;
ii) between 0.5 wt % and 15 wt % carbohydrate;
iii) between 0.5 wt % and 15 wt % fat; and
iv) between 0.5 wt % and 15 wt % ash; and
(c) curing the binder applied to the collection of matter by applying energy to the collection of matter to form the product.

According to another aspect, the present invention provides an aqueous binder composition comprising, by dry weight:

i) between 65 wt % and 90 wt % whey protein;

ii) between 0.5 wt % and 15 wt % carbohydrate;

iii) between 0.5 wt % and 15 wt % fat; and

iv) between 0.5 wt % and 15 wt % ash.

According to a further aspect, the present invention provides an aqueous binder composition comprising between 65 wt % and 90 wt % whey protein by dry weight and a combined quantity of impurities selected from the group consisting of carbohydrate, fat and ash of at least 1% by dry weight.

According to a yet further aspect, the present invention provides a method of manufacturing a product, notably a product selected from a building product, a mineral wool insulation product, a wood product, an automotive product, a paper product and a refractory product, comprising the steps of:
(a) providing a collection of matter,
(b) applying an aqueous binder composition to the collection of matter, the aqueous binder composition comprising between 65 wt % and 90 wt % whey protein by dry weight and a combined quantity of impurities selected from the group consisting of carbohydrate, fat and ash of at least 1% by dry weight; and
(c) curing the binder applied to the collection of matter by applying energy to the collection of matter to form the product.

The term “whey protein” as used herein means protein(s) derived from whey and relates notably to a collection of globular proteins isolated from whey, the liquid material created often as a by-product of cheese production. Whey protein is typically a mixture of four major protein fractions and six minor protein fractions. The four major protein fractions in whey are beta-lactoglobulin, alpha-lactalbumin, bovine serum albumin and immunoglobulins, which are soluble in their native forms, independent of pH. Typically, whey protein has a molecular weight of about 700 to 1,000 g/mol, and contains thiol groups which can oxidize into disulfide groups. Accordingly, the polymerization of whey protein is due to disulfide formation, which does not produce water such as in condensation reactions.

The term “whey protein preparation” as used herein means a mixture of whey protein and other materials, notably impurities such as ash and/or, fat and/or carbohydrate in addition to the protein fractions. The whey protein preparation may be a by-product, notably from cheese production; it may be prepared with or without filtration and/or with or without some purification and/or separation.

The whey protein preparation may comprise one or more of the following:

| components | Whey | Whey | Acid | Hydrolyzed |
|---|---|---|---|---|
| (range in | protein | protein | whey | whey |
| wt.-%) | concentrate | Isolate | protein | protein |
| protein | 70-89 | >90 | 83 | 81 |
| lactose/carbohydrate | 4-7 | 0.6 | 4 | 5.3 |
| fat | 3-7 | 1 | 2.1 | 4 |
| moisture/ash | 5-15 | 1-9 | 11 | 3.5 |

As used herein, the expression “dry binder composition” relates to the total amount of solids in the binder composition, i.e. the binder composition of the present invention excluding water. Similarly, the term “by dry weight” means with respect to the total amount of solids present.

The term “aqueous” as used herein relates to a solution and/or dispersion which comprises water as a solvent and/or carrier, notably where water comprises at least 50 wt %, 60 wt %, 70 wt % or 80 wt % of the solvent(s) present. The term “aqueous” also includes compositions or mixtures which contain water and one or more additional solvents, such as organic solvents.

The aqueous binder, particularly in respect of the further aspect and yet further aspect described above, may comprise the following quantities of the following components (either individually or in combination) by dry weight:

i) a quantity of carbohydrate which ≧0 wt %, ≧0.5 wt %, ≧1 wt %, ≧2 wt %, ≧3 wt % or ≧4 wt %; and/or

ii) a quantity of carbohydrate which ≦15 wt %, ≦12 wt %, ≦10 wt % or ≦8 wt %; and/or

iii) a quantity of fat which ≧0 wt %, ≧0.5 wt %, ≧1 wt %, ≧1.5 wt % or ≧2 wt %; and/or

iv) a quantity of fat which ≦15 wt %, ≦12 wt %, ≦10 wt % or ≦8 wt %; and/or

v) a quantity of ash which ≧0 wt %, ≧0.5 wt %, ≧1 wt %, ≧2 wt % or ≧3 wt %; and/or

vi) a quantity of ash which ≦15 wt %, ≦12 wt %, ≦11 wt %, ≦10 wt % or ≦8 wt %.

The use of an aqueous binder composition which comprise at least 95% by dry weight of whey protein preparation(s) provides good binder performance whilst allowing significant use of an available natural by-product. Preferably, the aqueous binder composition comprises at least 96 wt %, 97 wt % or 98 wt % whey protein preparation based on the total weight of the dry binder components.

Commercially available whey protein preparation may comprise impurities such as ash, fat or carbohydrate. Such impurities generally have a negative impact on the polymerization rate and the resulting internal bond strength and may even completely inhibit polymerization of the proteins of the whey protein preparation. Accordingly, the amount of impurities in the whey protein preparation and thus in the binder composition of the present invention should be selected so as not to significantly hinder desired binder properties. Nevertheless, one aspect of the invention relates to the use of an aqueous binder composition comprising levels of particular impurities such as ash, fat or carbohydrate that allow the use of desirable staring materials whilst still providing desirable binder properties. The whey protein preparation of the present invention may comprises a total amount of impurities (i.e. components other that whey protein such as ash, fat or carbohydrate) which is ≦40 wt % based on the total weight of the dry whey protein preparation, notably ≦35 wt %, ≦30 wt %, ≦25 wt %, ≦15 wt % or ≦10 wt % and/or which is ≧2 wt %, ≧5 wt % or ≧10 wt %.

Particularly carbohydrate impurities such as lactose, galactose, glucose, etc. have an adverse effect on the binder composition of the present invention, and thus the amount of carbohydrate in the binder composition of the present invention should be low. Preferably, the whey protein preparation comprises an amount of carbohydrate, based on the total weight of the dry whey protein preparation, which is ≦15 wt.-% more preferably ≦12 wt %, ≦10 wt %, ≦7.5 wt % or ≦5 wt %. The whey protein preparation may contain an amount of carbohydrate which is ≧0.5 wt %, ≧1 wt % or ≧3 wt %.

In preferred embodiments, the aqueous binder composition does not include cross-linking agents other than those present or comprised in the whey protein of whey protein preparation. In other embodiments, the aqueous binder solution may comprise additional cross-linking compounds. Such additional cross-linking compounds may be present in the aqueous binder composition in an amount by dry weight of ≧0.5%, ≧1%, ≧2% or ≧3% and/or ≦5%, or ≦4%.

The aqueous binder composition may comprise one or more polymerization modifier(s), which may act(s) as catalyst and may enhance the polymerization rate and/or resulting internal bond strength. The polymerization modifier may comprise inorganic salts, organic salts, pH-modifiers, of mixtures thereof. The polymerization modifier may comprise one or more anions selected from hydroxide, chloride, bromide, carbonate, sulphate, phosphate and nitrate; it may be selected from NaOH, NaCl, KCl, CaCl₂, NH₄Cl, NaBr, KBr, CaBr₂, NH₄Br, Na₂CO₃, K₂O0₃, CaCO₃, (NH₄)₂CO₃, Na₂SO₄, K₂SO₄, CaSO₄, (NH₄)₂SO₄, Na₃PO₄, K₃PO₄, Ca₃(PO₄)₂, (NH₄)₃PO₄, NaNO₃, KNO₃, Ca(NO₃)₂ and NH₄NO₃. The amount of polymerization modifier used in the binder composition of the present invention is not particularly restricted and depends on the modifier as well as on the overall composition of the binder. Generally, the polymerization modifier, e.g. an inorganic salt such as CaCO₃, is present in the binder composition in an amount of 0.1 to 15 wt.-%, such as 1 to 13 wt.-%, 2 to 11 wt.-% or 3 to 9 wt.-%, based on the total weight of the dry binder composition.

According to one embodiment, the binder composition of the present invention has a pH of >6. Since a higher pH value catalyses the polymerization of the proteins of whey protein preparations, addition of alkaline polymerization modifiers such as NaOH, CaCO₃ and Na₂CO₃ may enhance the polymerization rate and/or the resulting internal bond strength.

According to a preferred embodiment, the whey protein preparation in the binder composition of the present invention is not hydrolyzed. Hydrolyzed whey protein polymerizes only slowly, if at all, so that the resulting binder composition would suffer from low cure rates. As used herein, the expression “hydrolyzed whey protein” relates to whey protein that has been processed by acid treatment and/or heat treatment.

Any surfactant binder additives influence the wetting properties of the aqueous binder composition in respect to the material to be bound (e.g. fibres or particles). As used herein, the term “surfactant” includes surfactants such as CDE/G from Albion. Preferably, the content of surfactant in the binder composition is in the range of 0.1 to 10 wt.-% based on the total weight of the dry binder composition, such as 0.2 to 8 wt.-%, 0.5 to 6 wt.-% or 1 to 4 wt.-%.

Particularly for mineral wool applications, the aqueous binder composition may comprise a silane or silicon-containing additive notably selected form gamma-aminopropyltriethoxysilane, gamma-glycidoxypropyltrimethoxysilane, aminoethylaminopropyltrimethoxysilane, an aminofunctional oligomeric siloxane and mixtures thereof, for example in an amount based on the total weight of the dry binder composition which is ≧0.1 wt %, ≧0.2 wt % or ≧0.5 wt % and/or ≦8 wt %, ≦5 wt % or ≦4 wt %.

The aqueous binder composition may comprise an amount of solids, based on the total weight of the aqueous binder composition, which is:
≧10 wt %, ≧12 wt % or ≧14 wt % and/or ≦25 wt %, ≦20 wt % or ≦18 wt %, notably for mineral wool applications; or
≧40 wt %, ≧45 wt % or ≧50 wt % and/or ≦75 wt %, ≦70 wt % or ≦65 wt %, notably for wood board applications.

The term “collection of matter” as used herein includes collections of matter which comprise fibres selected from the group consisting of mineral fibres (including slag wool fibres, stone wool fibres, glass fibres), aramid fibres, ceramic fibres, metal fibres, carbon fibres, polyimide fibres, polyester fibres, rayon fibres, and cellulosic fibres. Further examples of a collection of matter include: particulates such as coal, sand, cellulosic fibres, wood shavings, sawdust, wood pulp, ground wood, wood chips, wood strands, wood layers, other natural fibres such as jute, flax, hemp, and straw, wood veneers, facings, wood facings, particles, woven or non-woven materials (e.g. comprising fibres, notably of the type(s) referred to above). According to a specific embodiment, the collection of matter is selected from wood particles and mineral fibres.

The expression “applying the binder composition” includes any process which is suited to bring the binder in contact with the collection of matter. Preferred examples of binder application include spraying the binder composition, e.g. in form of an aqueous solution and/or dispersion onto the collection of matter or mixing the collection of matter with such a binder composition.

The term “applying energy to the collection of matter” includes any means which are suited to polymerize the whey protein (and any additional cross-linking compounds) in the binder composition in order to obtain a polymeric cured binder, for example applying heat, notably heating in an oven or press at a temperature of 50° C. to 280° C., depending on the type of matter, the amount of binder and other conditions.

Specific examples of the temperature range include 60 to 280° C., 70 to 280° C., 80 to 280° C., 90 to 280° C., 100 to 280° C., 115 to 280° C., 130 to 280° C., 150 to 280° C., 175 to 280° C., 200 to 280° C. and 225 to 280° C. Other specific examples of the temperature range include 50 to 250° C., 50 to 225° C., 50 to 200° C., 50 to 175° C., 50 to 150° C., 50 to 130° C., 50 to 115° C., 50 to 100° C., 50 to 90° C. and 50 to 80° C. According to the present invention, the temperature for curing is not limited to the above ranges, and the upper and lower values of said ranges may be freely combined.

Similarly, the duration for applying energy in the above method is not specifically restricted and includes durations of 1 to 240 minutes, 1 to 210 minutes, 1 to 180 minutes, 1 to 150 minutes, 1 to 120 minutes, 1 to 90 minutes, 1 to 75 minutes 1 to 60 minutes, 1 to 40 minutes, 1 to 30 minutes, 1 to 20 minutes, 1 to 15 minutes, 1 to 10 minutes and 1 to 5 minutes. Further examples include durations of 2 to 240 minutes 5 to 240 minutes, 10 to 240 minutes, 15 to 240 minutes, 20 to 240 minutes, 25 to 240 minutes, 30 to 240 minutes, 40 to 240 minutes, 45 to 240 minutes, 60 to 240 minutes, 120 to 240 minutes and 180 to 240 minutes. Moreover, the proteins of the whey protein preparations may also be polymerized within the above time ranges at room temperature by addition of a catalyst such as e.g. (concentrated) NaOH. According to the present invention, the duration for polymerizing the proteins of the whey protein preparations is not limited to the above ranges, and the upper and lower values of said ranges may be freely combined.

The figures show:

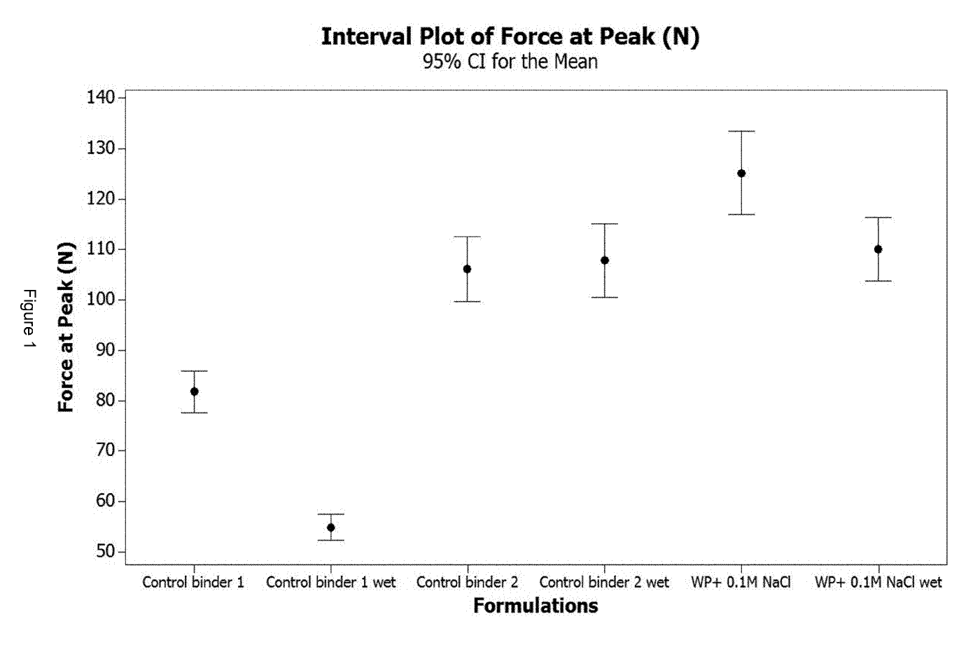

FIG. 1 shows a comparison of dry and wet strengths of whey protein binder compositions and control binders 1 and 2.

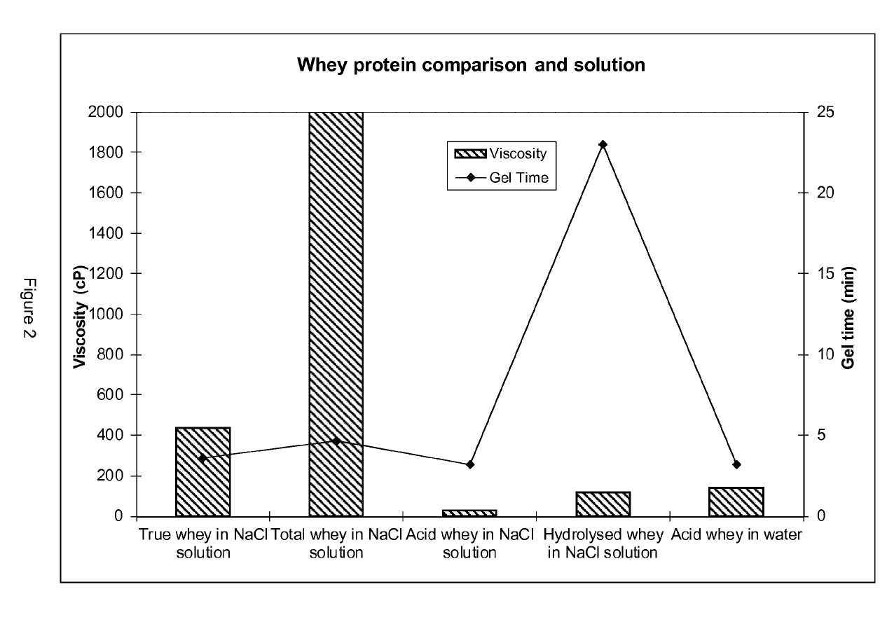

FIG. 2 shows a comparison of viscosity, gel-time properties of different whey protein binder compositions. All formulations were prepared at 39% wt.-% solids in salty water (NaCl), except for the last formulation which did not contain NaCl.

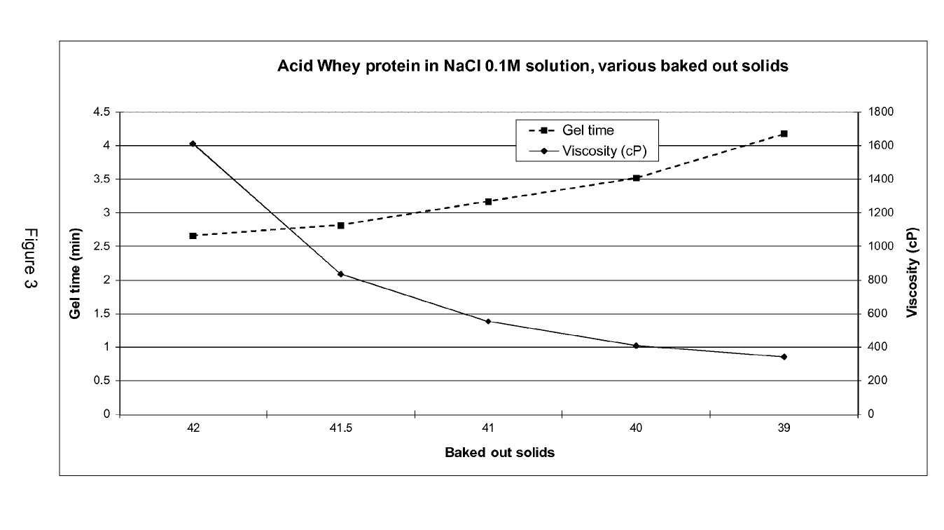

FIG. 3 shows a comparison of viscosity and gel time of acid whey protein binder compositions at various concentrations.

The binder composition of the present invention is compatible with the established processes, is sustainable since it is based on whey protein preparation as a natural by-product, and is particularly superior to phenol/formaldehyde or other sustainable binders both in internal bond strength and/or swelling properties due to only low loss of water during the curing process. Also, polymerization of whey protein preparation is very fast and takes place at low temperatures where the proteins do not undergo condensation reactions. This enables the effective production of strongly bound particle-based or fibre-based materials, such as insulation and construction panels.

### EXAMPLES

The present invention will be further illustrated in the following non-limiting examples.

### Example 1

### Production and Evaluation of a Binder Composition Containing Whey Protein Preparation

As a preliminary test, 4g of whey protein preparation (molecular weight 700 to 1,000 g/mol) was dispersed in a 0.1M NaCl (0.58 g) solution in water (100 mL). Within 1 hour of heating at 80° C., some white precipitate appears, showing polymerization of proteins of whey protein preparation. This polymerization is based on disulfide bond formation of sulfhydryl groups, so that limited loss in water is observed with whey protein binder compositions compared to other binders.

Subsequently, a 4% w/v whey protein preparation (16 g) in 0.1M NaCl (2.24 g) solution in water (384 mL) was prepared and cured on veil. In addition, a corresponding mix with potassium sulphate was also prepared.

Comparison of the veils' strength (dry and weathered), with state of the art control binders 1 and 2 of the carbohydrate/amine type (Maillard binders; cf. for example WO 2011/138459 A1) showed that whey protein binder compositions were superior to the afore-mentioned control binders in terms of bond strength. Veils' strengths were tested with a testometric, using a 50 kg load cell. Their corresponding forces at peak were measured in Newton. Weathering of the veils was performed in an autoclave for 1 h at 110° C. and 100% humidity (cf. FIG. 1).

This higher strength obtained by using the whey protein- binder composition can be explained with their high loss-on-ignition values (LOI). LOI is a measurement of binder content on a product. To measure said LOI, a binder-free veil sample is weighed (B), then binder is applied on the veil, cured at 200° C., placed in preheated muffle furnace set at 530° C. for at least 20 minutes, and weighed again (A). Corresponding LOI is calculated with the following formula:

$$LOI ( \% ) = ( \frac{Mass ( A ) - Mass ( B )}{Mass ( A )} ) 100$$

In particular, since whey protein binder compositions do not undergo condensation reaction while curing, their resulting LOI is about 1.5 times higher compared to state of the art Maillard binders. When strength was normalized, the bond strength of whey protein binder compositions was similar to that of state of the art Maillard binders.

Next, several whey protein preparations were compared using Gelnorm (formulations heated at 100° C. to identify their respective gel times). The compositions of the individual whey protein preparations were as follows:

TABLE 1
composition of various commercially available whey
protein preparations by wt %

| | true whey | total whey | acid whey | hydrolyzed |
|---|---|---|---|---|
| | protein | protein | protein | whey protein |
| Components | preparation | preparation | preparation | preparation |
| Whey protein | 76 | 77.5 | 83 | 81 |
| carbohydrate (pri- | 7.2 | 4 | 4 | 5.3 |
| marily lactose) | | | | |
| fat | 6.8 | 3.5 | 2.1 | 4 |
| moisture/ash | 10 | 15 | 10.9 | 3.5 |

Hydrolyzed whey protein reacted significantly slower than non-hydrolyzed whey protein. The fastest gel time was observed for acid whey protein. Addition of whey protein into distilled water, i.e. water containing no NaCl or other salts, gave a similar gel time which shows that whey protein binder composition can be a one component only binder (cf. FIG. 2).

Kinetic studies of a selected acid whey protein binder composition were conducted with several concentrations of acid whey protein in 0.1M sodium chloride solution. The viscosity remained below 500 cP while gel time reaches 3.5 minutes (cf. FIG. 3).

Viscosity was measured using a Brookfield DV-II+Pro viscometer coupled with a water temperature regulator Isotemp. The binders are poured into a small cell where a spindle turn into it and measure the resistance applied by the binder, which will give a measurement of viscosity in centipoise (cP). Gel times were measured using a TC-4 Gelnorm Heating systems ST/1 from Gel Instrumente AG. The binders were poured into test tubes heated at 100° C. where a rod moves up and down and lifts the whole test tube once the binder gels. This stops the timer which reads the gel time.

Acid whey protein in NaCl solution prepared with a concentration of 40 wt.-% solids resulted in a binder composition with acceptable viscosity and excellent gel time. When this formulation was baked out for 2 h at 140° C., the resulting baked out solids observed were also 40 wt.-%, which is an indication that the whey protein-containing binder formulations do not loose solids during polymerization.

### Example 2

### Evaluation of the Influence of Polymerization Modifiers in Whey Protein Binder Compositions on Gel Time

Several additives were used as polymerization modifiers to acid whey protein binder compositions (cf. Tables 2 and 3). Shortest gel times were obtained with carbonate salts and with surfactant. The surfactant used was “CDE/G” from Albion.

TABLE 2
Addition of 0.1M of salts in 40 wt.-% acid whey protein in water

| Additive | None | K₂SO₄ | AmPO₄ | AmSO₄ | K₂CO₃ |
|---|---|---|---|---|---|
| Gel time | 3′05″ | 3′00″ | 3′02″ | 3′15″ | 1′59″ |

TABLE 3
Additives are added to 42.86 wt.-% acid whey protein in water

| | | 3.5 wt.-% | 3 wt.-% | CaCO₃ + |
|---|---|---|---|---|
| Additive | None | CaCO₃ | Surfactant | surfactant |
| Solids (wt.-%) | 40.99 | 42.94 | 41.86 | 43.71 |
| Gel time | 2′40″ | 2′10″ | 2′00″ | 2′15″ |

### Example 3

### Production of Timber Board using Whey Protein Binder Compositions

Acid whey protein binder composition, with/without CaCO₃ as additive, was tested as a binder composition in the manufacture of timber boards. Swelling values (%) of produced timer boards were determined by the following procedure: The thickness of the sample was measured after its cure (T1 in [mm]) and then the sample was soaked in water at 20° C. for 2 hours (2H Swelling) or 24 hours (24H Swelling). After that, the sample was taken out of the water and its thickness was measured again (T2 in [mm]). Percentage of swelling was calculated by the following equation:

% swelling=(T2−T1)/T1*100

The swelling properties of the resulting timber boards were excellent. With addition of calcium carbonate to acid whey protein and 15 wt.-% binder addition in wood chips, the swelling was improved compared to control binder 3 (standard state of the art sustainable binder of the carbohydrate/amine type, i.e. Maillard binder; cf. for example WO 2011/138459 A1). This swelling improvement is due to either better covering of the wood chips with more binder added or faster cure with addition of CaCO₃ (2 minutes gel time). Without CaCO₃ and lower addition of binder (10%), the swelling remains comparable to control binder 4 (standard state of the art sustainable binder of the carbohydrate/amine type, i.e. Maillard binder; cf. for example WO 2011/138459 A1).

TABLE 4
Results of timber board production

| Whey | 10% binder | | |
|---|---|---|---|
| Press factor | IB (N/mm) | 2 H Swelling | 24 H Swelling |
| 10 s/mm | 0.268 | 45.27% | 56.43% |
| 12 s/mm | 0.300 | 46.42% | 58.94% |
| 16 s/mm | 0.304 | 43.46% | 53.72% |
| Whey + CaCO₃ | 15% binder | | |
| Press factor | IB (N/mm) | 2 H Swelling | 24 H Swelling |
| 12 s/mm | 0.378 | 29.22% | 34.33% |
| 16 s/mm | 0.375 | 30.91% | 36.70% |
| Control binder 3 | 10% binder | | |
| Press factor | IB (N/mm) | 2 H Swelling | 24 H Swelling |
| 10 s/mm | N/A | N/A | N/A |
| 12 s/mm | 0.443 | 49.48% | 56.40% |
| 16 s/mm | 0.935 | 44.90% | 56.25% |
| Control binder 4 | 6% binder | | |
| Press factor | IB (N/mm) | 2 H Swelling | 24 H Swelling |
| 10 s/mm | 0.466 | 41.1% | 48.4% |
| 12 s/mm | 0.609 | 39.8% | 45.9% |
| 16 s/mm | N/A | N/A | N/A |
| Control binder 1 | 8% binder | | |
| Press factor | IB (N/mm) | 2 H Swelling | 24 H Swelling |
| 12 s/mm | 0.910 | 31.43% | 36.21% |
| | 10% binder postcured | | |
| Whey | IB (N/mm) | | 24H Swelling |
| | 0.351 | | 27.61% |

As can be taken from the results shown in the above Table 4, the internal bond strength (IB reached at best 0.37N/mm) as determined by a tensiometer Testometric M350-10CT with a load cell of 1000 kg remains acceptable for P2 boards (typically used indoors) but too low for P4 boards (typically used outdoors, thus require higher internal bond strength and lower swelling values).

1. A method of manufacturing a product selected from a building product, a mineral wool insulation product, a wood product, an automotive product, a paper product and a refractory product, comprising the steps of:
(a) providing a collection of matter,
(b) applying an aqueous binder composition to the collection of matter, the aqueous binder composition comprising, by dry weight:
i) between 65 wt % and 90 wt % whey protein;
ii) between 0.5 wt % and 15 wt % carbohydrate;
iii) between 0.5 wt % and 15 wt % fat; and
iv) between 0.5 wt % and 15 wt % ash; and
(c) curing the binder applied to the collection of matter by applying energy to the collection of matter to form the product.

2. The method according to claim 1, wherein the binder holds the collection of matter together to form the product.

3. The method according to claim 1, wherein the collection of matter comprises matter selected from the group consisting of wood, wood particles, cellulose fibres and mineral fibres.

4. The method according to claim 1, wherein the aqueous binder composition comprises at least 95% by dry weight of whey protein preparation.

5. The method according to claim 1, wherein the aqueous binder composition comprises at least one additive selected from the group consisting of silanes, waxes, catalysts, surfactants and corrosion inhibitors, wherein the total amount of silanes, waxes, catalysts, surfactants and corrosion inhibitors by dry weight in the aqueous binder composition is in the range of 0.2 wt % to 6 wt %.

6. The method according to claim 1, wherein the aqueous binder composition further comprises one or more polymerization modifier(s) in an amount of 0.1 to 15 wt % based on the total weight of the dry binder composition, said one or more polymerization modifier(s) containing one or more anions selected from hydroxide, chloride, bromide, carbonate, sulphate, phosphate and nitrate, and provided by one or more of NaOH, NaCl, KCl, CaCl₂, NH₄Cl, NaBr, KBr, CaBr₂, NH₄Br, Na₂CO₃, K₂CO₃, CaCO₃, (NH₄)₂CO₃, Na₂SO₄, K₂SO₄, CaSO₄, (NH₄)₂SO₄, Na₃PO₄, K₃PO₄, Ca₃(PO₄)₂, (NH₄)₃PO₄, NaNO₃, KNO₃, Ca(NO₃)₂ and NH₄NO₃.

7. The method according to claim 1, wherein the aqueous binder composition comprises less than 30 wt % of ash, fat and carbohydrate.

8. The method according to claim 4, wherein the whey protein preparation comprises at most 15 wt % of carbohydrate, based on the total weight of the dry whey protein preparation.

9. The aqueous binder composition according to claim 4, wherein the whey protein preparation is a non-hydrolyzed whey protein preparation.

10. The method according to claim 1, wherein the aqueous binder composition has a pH of >6.

11. The method according to claim 1, wherein the aqueous binder composition comprises from 10 to 70 wt % of solids by dry weight, based on the total weight of the aqueous binder composition.

12. An aqueous binder composition comprising, by dry weight:
i) between 65 wt % and 90 wt % whey protein;
ii) between 0.5 wt % and 15 wt % carbohydrate;
iii) between 0.5 wt % and 15 wt % fat; and
iv) between 0.5 wt % and 15 wt % ash.

13. The aqueous binder composition according to claim 12, wherein the aqueous binder composition comprises at least 95% by dry weight of whey protein preparation.

14. A particle or fibre product comprising a collection of particles and/or fibres held together by a binder, in which the binder comprises the product of curing a binder composition according to claim 12.

15. (canceled)
